(19) United States
(12) Patent Application Publication
(10) Pub. No.: US 2024/0351794 A1
(43) Pub. Date: Oct. 24, 2024

(54) Control System and Method for Handling a Processing Product Transported on a Transport Device

(71) Applicant: Siemens Akiengesellschaft, Muenchen (DE)

(72) Inventors: Alexander Michael GIGLER, Untermeitingen (DE); Martin HÖFFERNIG, Graz (AT); Ingo THON, Grasbrunn (DE); Alexander KESSLER, Nürnberg (DE)

(21) Appl. No.: 18/637,616

(22) Filed: Apr. 17, 2024

(30) Foreign Application Priority Data
Apr. 18, 2023 (EP) 23168372

(51) Int. Cl. B65G 43/08

(52) U.S. Cl. CPC B65G 43/08; B65G 2203/0216

(57) ABSTRACT

A control system for handling a processing product includes a control device with at least one application module for interconnecting first and second sensor components, and a control module, wherein the first and second sensor components capture first and second sensor data, the handling component handles, processes and/or manipulates the processing product, and the control module executes the control program, and further includes an edge computing device which determines an item of time information, where times for transporting a product transported on the transport device from the first to the second sensor component and on to the handling component are determined from the item of time information, and wherein the control module executes the control program to provide real-time control of the handling component for handling the processing product taking into account the first and second sensor data and the time information and/or the determined transport times.

### BACKGROUND OF THE INVENTION

### 1. Field of the Invention

The present invention relates to a control system and method for handling a processing product transported on a transport device from a first to a second sensor component and on to a handling component, comprising a control device with at least one analysis module for connecting the first sensor component and the second sensor component and with a control module.

### 2. Description of the Related Art

U.S. Pat. No. 11,278,937, for example, discloses a material sorting system comprising various sensors and a camera system to identify and classify different materials. The sorting system comprises a conveyor belt on which the parts to be sorted are moved along the various sensors and then sorted by the different materials in a sorting station. The speed of the conveyor belt is measured using a speed sensor in order to then assign the sensor signals from the individual sensors to specific objects based on the speed of the objects on the conveyor belt.

It is a disadvantage of the above-mentioned prior art that such a method only works for one-piece conveyor belts, for example, and not for the use of multi-carrier systems, autonomous mobile transport systems or robots as a transport medium, for example.

### SUMMARY OF THE INVENTION

In view of the foregoing, it is therefore an object of the present invention to provide a system and/or method configured to sort and/or handle objects transported on a transport device, that can be adapted in a more flexible and easier manner.

This and other objects and advantages are achieved in accordance with the invention by a control system configured to handle a processing product transported by a transport device from a first to a second sensor component and on to a handling component, where the system comprises a control device with at least one application module for connecting the first sensor component and the second sensor component, and with a control module, where the first and second sensor components are configured to capture first and second sensor data relating to the processing product, the handling component is configured to handle, process and/or manipulate the processing product, and the control module is configured to execute a control program for controlling the handling component, where the control system further comprises an edge computing device that is configured to determine at least one item of time information, where times for transporting a product transported by the transport device from the first to the second sensor component and on to the handling component can be determined or are determined from the at least one item of time information, and where the control module is configured to execute a control program for real-time control of the handling component for handling the processing product taking into account the first and second sensor data as well as the time information and/or the determined transport times.

As a result of the fact that the edge computing device is not part of the control device and is further configured to determine the time information, it is possible to recalibrate the control system at any time without affecting its real-time properties that are significantly determined by execution of the control program in the control device. This makes it possible to adapt the system more flexibly to different transport systems or transport media. In addition, the control system can thus be adapted in an easier and more flexible manner to changed transport parameters.

In many industrial plants, information from multiple data sources must be combined to handle an automation task. Information relating to a “product” (e.g., a specific automobile), an “object” (e.g., a sugar beet on a bulk goods transport belt) or a section (production centimeter 2019 for glass) is often recorded at different points in time at different positions in the production process. The problem here is to correctly correlate this information with the object/product concerned, to correctly interpret the combination of the data and to execute the resulting actions and/or reactions in a timely manner. Nowadays, data collected at a sensor station are usually used directly at or in the immediate vicinity of this sensor station, e.g., in order to specifically grab, handle, sort and/or reject objects. The data are then discarded.

Some problems relating to recycling plants for example, in which, for example, the objects to be recycled are intended to be transported and sorted or rejected on a belt, are explained in more detail below.

A typical sensor system, which can be distributed along the transport belt of this type, can be composed, for example, of the following components:
a hyperspectral line scan camera capable, via machine learning, of classifying materials (e.g., types of plastics),
a magnetic sensor for distinguishing metallic from non-metallic objects,
an RGB camera for detecting shapes and determining sizes, possibly even as a 2.5D or 3D camera to determine volumes.

An actuator system is often necessary for sorting waste and can be formed as one or more delta pickers, 6-axis robots or, for example, compressed air-based sorters at a discharge point.

As described above, a core problem can be the concerted capture, processing and deterministic reaction of the system to the present transported goods, while the interaction becomes complex, especially under varying transport speeds.

The integration of complex sensors, which collect data from multiple points in the production plant at different times, must be coordinated to activate an actuator system in a time-discrete manner. Due to the scope and frequency, e.g., caused by high-resolution and fast cameras, the data load can often be a major problem for the existing infrastructure, which also means a considerable effort for the temporal orchestration of the actuator system.

Here, a control system, a handling system, a method for setting up a control system and/or a method for handling a processing product in accordance with the present description offer(s) a possible way of reducing or even solving the aforementioned problems through their flexibility and easier adaptability. In particular, the use of an edge computing device to determine the time information and the transport times, which is often complicated for the aforementioned reasons, relieves the control device of these tasks and enables faster, more predictable, more flexible and/or less disturbed real-time control of the handling component via the control device.

The transport device may be arranged and configured such that the processing product transported on it can be captured or is captured in the course of transport by the first and second sensor components, and can be handled or is handled in the further course of transport by the handling component.

The transport device can be formed, for example, as a conveyor belt, a transport belt, an overhead track with multiple carrying and/or gripping elements, a “multi-carrier system” consisting of multiple carrier elements that can be moved independently or in a manner dependent on one another, e.g., on a rail system, one or more robots, an Autonomous Guided Vehicles (AGV) system with one or more AGVs, an Autonomous Mobile Robot (AMR) system with one or more mobile robots, or as comparable devices or can comprise such devices.

The transport device may be configured, for example, such that multiple processing products or objects transported successively or in parallel thereon take the same transport route. In this case, such as in an AGV or AMR system, the individual AGVs or AMRs may or must be configured such that each of the individual transport elements always takes the same route. This is usually the case with a transport belt or a multi-carrier system with a rigid rail or guide system.

The transport device may also be configured, for example, such that multiple processing products or objects transported successively or in parallel thereon require the same time from the first to the second sensor component and the same time from the second sensor component to the handling system during their transport. The transport device may further be configured such that multiple processing products or objects transported successively or in parallel thereon travel along the transport route at the same speed or with the same speed profile or curve.

In this case, for example, in a multi-carrier, AGV or AMR system, the individual carrier elements, AGVs or AMRs may be configured such that, when transporting a processing product or object from the first to the second sensor component and on to the handling system, each respectively requires the same transport times between the first and second sensor components and on to the handling system and/or has the same speed profile or the same speed curve. This is usually the case with a transport belt.

In one advantageous embodiment, the transport device may further be configured such that multiple processing products or objects transported successively or in parallel thereon both take the same transport route and travel along the transport route at the same speed or with the same speed profile or curve.

Furthermore, the control system can also be configured to handle a processing product that is transported or can be transported on a transport device from a first to a second sensor component and on to at least one third sensor component and then on to a handling component and optionally at least one further handling component.

In this case, the at least one third sensor component is configured to capture third and optionally further sensor data relating to the processing product. Furthermore, the at least one third sensor component can be configured in accordance with a first and/or second sensor component in accordance with the disclosed embodiments. The third and optionally further sensor data may be configured in accordance with first and/or second sensor data in accordance with the disclosed embodiments. In this configuration, the at least one application module is then configured to connect the first sensor component, the second sensor component and the at least one third sensor component.

In this case, each of the optionally at least one further handling component can be configured in accordance with a handling component in accordance with the disclosed embodiments. Furthermore, in this case, the control module can be configured to execute a control program for real-time control of the handling component and the optionally at least one further handling component.

In this case, the edge computing device can then be configured to determine at least one item of time information, where times for transporting a product transported on the transport device from the first to the second and on to a possibly present at least one third sensor component and then on to the handling component and optionally the at least one further handling component can be determined or are determined from the at least one item of time information.

The control module is then configured to execute a control program for the real-time control of the handling component and optionally the at least one further handling component for handling the processing product.

Sensor data within the meaning of the present invention can be all data that are output or can be output by a sensor component in accordance with the disclosed embodiments. Furthermore, sensor data may also be data consisting of or comprising data originating directly from a sensor component or data obtained after a processing step, for example. Such processing steps may include, for example, a pre-processing of data originating from the sensor, such as a normalization, a conversion, a time stamping or other typical processing and/or before processing steps involving sensor data.

The fact that the control module is configured to execute a control program for real-time control of the handling component taking into account sensor data can be configured such that sensor data originating directly from a sensor component are taken into account in the context of the real-time control and/or that data generated after a pre-processing and/or processing step are incorporated into the real-time control. Furthermore, it can be provided that the real-time control, taking into account the sensor data, is configured such that further information, for example, product information in accordance with the present disclosure, are generated by analysing the sensor data, and the control module is configured to execute a control program for the real-time control of the handling component taking into account the sensor data such that at least, inter alia, the product information or the further information is taken into account or used.

A sensor component in accordance with the present disclosure can be configured, for example, as a camera (e.g., hyperspectral line scan camera or RGB camera), an optical line sensor, an optical sensor, a magnetic sensor, a motion sensor, a location sensor, a material sensor, a touch sensor, and/or any other type of sensor.

The first and second sensor components as well as the at least one third sensor component may be configured, for example, as
a hyperspectral line scan camera capable, via machine learning, of classifying materials (e.g., types of plastics),
a magnetic sensor for distinguishing metallic from non-metallic objects, and/or
an RGB camera for detecting shapes and determining sizes, which may possibly be configured even as a 2.5D or 3D camera to determine volumes, for example.

Sensor data can be all data output by a sensor component according to the present description and/or transmitted to an external device, such as an application module according to the present description. Such sensor data can be, for example: optical data (e.g., 0D data, 1D data, 2D image, 3D image), electrical properties or information (e.g., resistance, and/or conductivity), magnetic properties or information, volume measurands, area measurands, state data (e.g., pressure, and/or temperature), motion parameters (e.g., location, speed, flow volume, and/or flow rate) or other sensor data. Sensor data may also be or include, for example, all data obtained from the above-mentioned data by pre-processing or further processing or analysis.

The handling component and/or the at least one further handling component may be any type of apparatus that can perform or performs an activity on and/or with the processing product. The handling component can be, for example, a robot (e.g., a delta picker or 6-axis robot), a compressed air device (e.g., a compressed air-based sorter), a handling machine, a machine tool, a furnace, or any other type of handling or processing apparatus suitable for a processing product.

The processing product may be a product, an object, an assembly, an element, a mechanical component or the like that is intended for handling and/or processing, is handled and/or processed, and/or can be handled and/or processed. Handling or processing is understood as meaning, for example, assembling, installation, assembly or production of a product or intermediate product, or handling, deformation, modification, sorting, selection, gripping or manipulation of the processing product, or disassembly, recycling and/or dismantling of the processing product or parts thereof.

The control device may be any type of computer or computer system that is configured to control an apparatus, a machine, a plant or a device. The controller can also be a computer, a computer system or a “cloud”, on which control software or a control software application, such as a control application, is implemented, instantiated or installed. Such a control application implemented on a computer or in a cloud can be configured, for example, as one or more applications with the functionality of a programmable logic controller.

The control device can furthermore also be configured as an edge device, where such an edge device can comprise, for example, an application for controlling apparatuses or plants. For example, such an application can be configured as an application with the functionality of a programmable logic controller. The edge device may be connected, for example, to a further control device of an apparatus or plant or may be connected directly to an apparatus or plant to be controlled. Furthermore, the edge device can be configured such that it is additionally also connected to a data network or a cloud or is configured for connection to a corresponding data network or a corresponding cloud.

The control device may also be configured, for example, as a programmable logic controller (PLC). Furthermore, the control device can also be configured as a modular programmable logic controller (modular PLC).

The control module may be a component of the control device which is configured to execute a control program. For example, the control module may include a functionality defined by the international Electrotechnical Commission (IEC) standard 61131.

The control module can be configured, for example, as a software application that is configured for real-time execution of a control program for controlling the handling component. For example, the software application may include a functionality defined in the IEC 61131 and/or IEC 61499 standard.

The control module may furthermore also be configured as a separate electronic module or a separate assembly that is configured for real-time execution of a control program. Such an electronic module or such an assembly may also include, for example, a functionality defined by the IEC 61131 and/or IEC 61499 standard. For example, the control module may be configured as a programmable logic controller itself or, for example, as a central module of a modular programmable logic controller. For example, the control module may include a functionality of an input/output assembly or may not include any functionality of an input/output assembly.

A programmable logic controller, or PLC for short, is a component that is programmed and used to regulate or control a plant or machine. In PLCs, specific functions such as sequence control can be implemented so that both the input and the output signals of processes or machines can be controlled in this way. The programmable logic controller is defined, for example, in the IEC 61131 and/or IEC 61499 standard.

In order to connect a programmable logic controller to the plant or machine, both actuators, which are generally connected to the outputs of the programmable logic controller, and sensors are used. Status indicators are also used. In principle, the sensors are located at the PLC inputs, whereby the programmable logic controller receives information about what takes place in the plant or machine. Sensors are considered to be, for example: light barriers, limit switches, pushbuttons, incremental encoders, level sensors, flow sensors, pressure sensors, temperature sensors or comparable sensors. Actuators are considered to be, for example, contactors (e.g., for switching on electric motors), electrical valves for compressed air or hydraulics, drive control modules, motors, drives.

A PLC can be implemented in various ways. This means that it can be implemented as an electronic single device, as a modular electronic device, as a software emulation, as a “virtual PLC” or “soft PLC”, as a PC plug-in card or the like. Modular solutions, in which the PLC is assembled from multiple plug-in modules, are often also found. Such modules can be, for example, a central control module, an input/output module, a communication module, a converter module, an application module or comparable modules.

A virtual PLC or a “soft” PLC is understood as meaning a programmable logic controller that is implemented as a software application and can run or runs on a computer device, an industrial PC or other PC, a computing device, or, for example, an EDGE device. Here, it is also possible to establish a virtual PLC or soft PLC in a modular manner. In this case, individual functionalities of a programmable logic controller or PLC are then structured as individual software modules that are connected or can be connected via middleware.

Such modules may be or include, for example, a central control software module (e.g., comprising at least, inter alia, a functionality specified by the IEC 61131 standard). Modules may also be or include communication modules for coupling to a field bus, to certain devices or apparatuses, to an Ethernet, an Open Platform Communications Uniform Architecture (OPC-UA) or comparable communication standards, a web server module, a human machine interface (HMI) module and/or a function module or application module according to the present description.

A modular programmable logic controller may be configured such that multiple modules can be or are provided, where in addition to a central module (also referred to as a control central module or CPU) that is configured to execute a control program, for example, for controlling a component, machine or plant (or part of it), one or more expansion modules may usually be provided. Such expansion modules may be configured, for example, as a current/voltage supply or for the input and/or output of signals or further also as a function module or application module.

An application module in accordance with the present disclosure can be configured, for example, as an input/output module or can include such a functionality. Furthermore, an application module according to the present disclosure may be configured, for example, to undertake special tasks and/or to provide special functionalities or may include such functionalities. Such special tasks or functionalities can be or include, for example: a counter, a converter, sensor data processing, sensor data pre-processing, time stamping, data analysis, image processing, video processing, and/or data processing with artificial intelligence methods (e.g., using a neural network or another machine learning (ML) model).

For example, a function module or application module may also be configured as an artificial intelligence (AI) module or machine learning (ML) module for performing actions using artificial intelligence methods or machine learning methods. Such a function module may include, for example, a neural network or an ML model in accordance with the present disclosure.

In this case, the at least one application module may comprise an application module that is configured and provided for the connection of both the first and the second sensor component. Furthermore, it can be provided, for example, that the at least one application module comprises a first application module for connecting the first sensor component and a second application module for connecting the second sensor component.

For example, an application module may be configured as a hardware module, for example, a hardware module for a programmable logic controller. Such a hardware module can be configured, for example, as a structurally independent module. Such a structurally independent hardware module may have, for example, a housing and/or mechanical elements or apparatuses for coupling to the control device or for mechanical integration into the control device.

Furthermore, the application module can be integrated into the control device and there can form, for example, a separate assembly or software application.

Furthermore, an application module can be configured as a software module. Here, for example, a control device may comprise this software module and the control device may further be configured to execute this application module formed as a software module.

In one advantageous embodiment, an application module is part of the control device. For example, the application module may logically belong to the control device. Furthermore, the application module can be mechanically coupled to the control device or mechanically integrated into the control device. The application module can also be configured as a software application, where the control device can then comprise the application module formed as a software application.

An application module can be configured as a freely programmable application module. Freely programmable firmware makes it possible to provide a freely programmable or independently programmable “application” or “app” that is executed as part of the firmware and/or is executed within the framework of a runtime environment provided by the application module.

A freely programmable application module can be configured, for example, to execute software or programs that are created and executed in a programming language that is not supported by the other or remaining components and/or modules of the control device. In particular, a freely programmable application module can be configured, for example, to execute software or programs that are created and/or executed in a programming language that is not defined as programming languages for such devices by the IEC 61138 standard or comparable standards with regard to control devices and/or programmable logic controllers.

In one advantageous embodiment, a freely programmable application module is not configured to execute programs that have been or are created in a programming language in accordance with IEC 61131, IEC 61499 or a comparable standard. Such IEC 61131 or IEC 61499 programming languages are the programming languages: instruction List (IL), ladder diagram (LD), function block diagram (FBD), sequential function chart (SFC) and structured text (ST).

A freely programmable application module for a control device may be configured, for example, such that it executes a software application in addition to a control program for controlling the machine or plant that is executing in the control device. Such a freely programmable application module makes it possible to implement a functionality of the control device in addition to a standard control functionality, which is implemented, for example, by a central control module for the control device. The central control module may be configured, for example, to execute the control program for controlling the machine or plant. The central control module may also be configured, for example, in accordance with the IEC 61131 standard, IEC 61499 standard and/or comparable standards for programmable logic control devices or at least may include such a functionality.

Examples of such application modules can be, for example, hardware or software modules for executing machine learning applications. Other examples of such application modules are, for example, hardware or software modules for implementing Boolean processors, for implementing or conducting simulations or executing simulation programs, for analysing images (e.g., camera images) or videos, e.g., inter alia, for recognizing objects and/or 2D or 3D forms, for programming or executing mathematical algorithms, analytical methods or big data analyses, for executing independent programs in one or more predefined programming languages (e.g., C, C++, Python, . . . ) or comparable uses or applications.

In connection with the present disclosure, an edge device is understood as meaning a communication device, computer device and/or control device that is communicatively connected or can be connected to or is integrated into an automation system (e.g., a control device, a control system and/or a handling system in accordance with the disclosed embodiments). Furthermore, an edge device is configured at least for additional connection to a further communication network not belonging to the automation system. Furthermore, the edge device can also be connected or connectable to a further communication network not belonging to the automation system. Such a further communication network that does not belong to the automation system can be, for example, a cloud, a company communication system or network (e.g., a company intranet) or a public communication network (e.g., an Internet, a WLAN, an Ethernet, a mobile radio network, a fixed line network (e.g., a DSL network) or the like). The edge device can also be, for example, part of the automation system and, for example, as a kind of gateway, establish a connection to communication systems outside the automation system or have the option of establishing such a connection.

For example, an edge device may include an application for controlling apparatuses or plants. For example, such an application can be configured as an application with the functionality of a programmable logic controller. The edge device may be connected, for example, to a further control device of an apparatus or plant or may be connected directly to an apparatus or plant to be controlled. Furthermore, the edge device can be configured such that it is additionally also connected to a data network or a cloud or is configured for connection to a corresponding data network or a corresponding cloud.

An edge device can also be configured to implement additional functionalities in connection with, for example, the controller of a machine, plant or component, or parts thereof. Such functionalities can be, for example:
collect and transmit data to the cloud and/or appropriate pre-processing, compression and/or analysis of such data for transmission to the cloud or from the cloud;
an analysis of data, e.g., with AI methods, e.g., with neural networks or corresponding ML models. For example, the edge device can use an ML model for this purpose.
management or implementation of training of a neural network or ML model. The training itself can occur at least partially in the edge device itself, or at least also in a cloud, among other things. If training occurs in a cloud, then the edge device can be configured, for example, to download the trained neural network or ML model and subsequently use it.

The at least one item of time information, for example, can be configured such that times for transporting any product transported on the transport device from the first to the second sensor component and on to the handling component can be determined or are determined from the at least one item of time information.

In this case, the at least one item of time information may comprise, for example, time data relating to capture or detection of a particular product by the first sensor component, the second sensor component and the handling component or may consist of such time data.

Furthermore, the at least one item of time information may comprise, for example, a time for transporting any object from the first to the second sensor component, as well as a time for transporting this object from the second sensor component to the handling component or may consist of these transport times. As a further example, the at least one item of time information may comprise, for example, a time for transporting any object from the first sensor component to the second sensor component, as well as a time for transporting this object from the first sensor component to the handling component or may consist of these transport times.

Furthermore, it can be provided, for example, that the at least one item of time information and/or the times for transporting a product transported on the transport device from the first to the second sensor component and on to the handling component (or variables derived therefrom) is/are each assigned to a product detected by the first and second sensor components. This assignment can be performed, for example, when storing the at least one item of time information together with ID information and/or a designation for a corresponding detected product or by way of comparable suitable assignment types. In this way, by virtue of the known transport times from the first to the second sensor component and from the second sensor component to the handling component, the handling component can then implement handling or processing in a manner based on the first and second sensor data relating to this product.

It may also be provided that the at least one item of time information and/or the times for transporting a product transported on the transport device from the first to the second sensor component and on to the handling component (or variables derived therefrom) is/are each assigned to a product detected by the first and second sensor components and the handling component. This assignment can also be implemented, for example, when accordingly storing the time information together with ID information for the corresponding detected product. This can be provided or performed, for example, when calibrating a corresponding handling system, for example, by the edge computing device.

The real-time control of the handling component, and/or an optionally available at least one further handling component, is implemented with indirect or direct use of the first and second sensor data and optionally using third and optionally further sensor data. Furthermore, the real-time control of the handling component is performed with indirect and/or direct use of the time information in accordance with the present description.

In this case, indirect use of the first and/or second sensor data is understood as meaning, for example, that further information, such as relating to a material, a shape or other property of a processing product, is determined based on determined sensor data, and the real-time control of the handling component is then performed using this determined information. The same applies to the indirect use of the time information.

In another advantageous embodiment, the at least one application module is configured to determine first product information using the first sensor data and second product information using the second sensor data, where the control module is configured to execute a control program for the real-time control of the handling component for handling the processing product taking into account the first and second product information relating to the processing product as well as the time information and/or the determined transport times.

In general, product information can be all information that is characteristic of a processing product and/or represents properties of a processing product. Furthermore, product information may also be configured, for example, such that it makes it possible to identify or characterize a processing product or product properties of a processing product and/or contributes to this.

Product information can be any information that represents at least one geometric, physical, chemical or other property of a processing product. For example, geometric properties may be a 2D outline, an outer shape, a 2D projection, a 3D shape, an outer shape, or comparable information relating to an outer shape of a processing product.

For example, product information may also be or include one or more materials of which a product consists or at least partially or predominantly consists.

Physical and/or chemical properties may be, for example, material properties such as electrical conductivity, thermal conductivity, magnetic properties, thermal capacities, optical properties (for example a refractive index, transparency, reflection properties, absorption properties, a penetration depth or the like) or the like.

Furthermore, characteristic properties can be, for example, surface properties such as a color, roughness, reflectivity or the like.

Product information may also include or consist of identification information or ID information, such as alphanumeric characters, a barcode, a QR code, and/or an RFID tag, which can be configured, for example, to characterize, name or type of a workpiece or product and/or to uniquely identify a product. In this case, the ID information can be configured, for example, such that it can be captured or detected or is captured or detected by different sensor types.

For the purposes of the present disclosure, the determination of such product information may represent, for example, indirect use of the sensor data. In this sense, the real-time control of the handling component is then performed using the first and second product information relating to the processing product as well as the time information and/or the determined transport times.

Thus, for example, materials, material properties and/or other properties of a processing product can be determined using the first and second sensor data, and handling of the processing product adapted to these determined properties can be performed by the handling component. The assignment of the first and second product information to the same processing product, as well as the specific control of the handling component with respect to this processing product, is then performed using the time information and/or the determined transport times between the sensor devices and the handling component.

Furthermore, the at least one application module may comprise a first ML model for determining the first product information and/or a second ML model for determining the second product information.

It may be provided, for example, that the first and/or second ML model is implemented in the at least one application module such that it is used or can be used at least when determining the first and/or second product information.

Possible applications for the use of such an ML model for determining product information can be, for example, the evaluation of one or more captured images of a processing product. Such an evaluation of one or more captured images can be configured, for example, to determine a product, a product type, a product material, a product surface property, a product appearance, a product shape, a product type, a product position or, for example, gripping points for gripping a processing product or to determine similar information relating to a captured product. Furthermore, an ML model can also be used to determine, for example, a product material or product materials or comparable physico-chemical or similar properties from captured sensor data.

An ML model or “machine learning” model is understood as meaning, in particular within the scope of the present disclosure, the result of applying a machine learning algorithm or learning method to specific data. An ML model represents the digitally stored or storable result of applying the machine learning algorithm or learning method to the analysed data.

Data for creating and/or training an ML model in accordance with the present disclosure may be, for example, historical data from the first and/or second sensor components or may include such data. Further, data for creating and/or training the ML model may include historical data from sensor components that are structurally identical, similar or comparable to the first and/or second sensor component, or historical data from sensors of the same category or type as the first and/or second sensor component.

When using an ML model or the ML model with sensor data from further sensors, or when using further ML models with sensor data from further sensors, such an ML model can also be created and/or trained with historical data from these sensors, comparable sensors or sensors of a similar or comparable sensor type.

In this case, a machine learning method is understood as meaning, for example, an automated (“machine”) method that does not generate results via rules defined in advance, but in which a machine learning algorithm or learning method is used to (automatically) identify, from many examples, regularities, on the basis of which statements about data to be analyzed are then generated.

Such machine learning methods may be configured, for example, as a supervised learning method, a partially supervised learning method, an unsupervised learning method or a reinforcement learning method.

Examples of machine learning methods are, for example, regression algorithms (e.g., linear regression algorithms), generation or optimization of decision trees, learning methods or training methods for neural networks, clustering methods (e.g., “k-means clustering”), learning methods for or generation of support vector machines (SVM), learning methods for or generation of sequential decision models or learning methods for or generation of Bayesian models or networks.

One example of a machine learning method is “linear regression”. Linear regression is a parametric method in which the labels are approximated by weighting all features. In a standard embodiment of the linear model, the mean squared error (MSE) is minimized in the optimization. There are other embodiments of the linear model that differ according to the form of the error function. One embodiment is, for example, the Huber estimator, in which a parameter & is introduced, for example, in order to eliminate outliers in the inputs.

Another example of a machine learning method is the k-nearest neighbours method. The principle of the k-nearest neighbours (k-NN) model is to determine the k nearest inputs for each input. It is a non-parametric method in which the similarity criterion is a defined metric. This metric can be a norm or distance that can be determined for all inputs. The neighbourhood of the labels is derived from the neighbourhood or similarity of the inputs.

Decision trees are another example of an ML model based on a machine learning method. A decision tree (DT) is a hierarchical structure that can be used to implement a non-parametric estimation. During data processing with decision trees, the inputs are divided into local regions whose distance to each other is defined by a specific metric. These local regions are the decision trees.

A decision tree is a sequence of recursive divisions consisting of decision nodes and end nodes or leaves. For each decision node, a defined function, the “discriminant function”, is used to make a discrete decision, the result of which (yes or no) leads to the following nodes. If a leaf node is reached, then the process ends and an output value is supplied.

The result of such an application of such a machine learning algorithm or learning method to certain data is referred to, in particular in the present disclosure, as a “machine learning” model or ML model. Such an ML model represents the digitally stored or storable result of applying the machine learning algorithm or learning method to the analysed data.

The generation of the ML model can be configured such that the ML model is newly formed by applying the machine learning method or an already existing ML model is modified or adapted by applying the machine learning method.

Examples of such ML models are results of regression algorithms (e.g., a linear regression algorithm), neural networks, in particular trained neural networks, decision trees, the results of clustering methods (including, e.g., the clusters or cluster categories, definitions and/or parameters obtained), support vector machines (SVM), sequential decision models or Bayesian models or networks.

In addition, different categories of ML models can also be combined to form an overall ML model. Such a model combination (ensemble learning) is the linking of different ML models in order to achieve better inference. The combined ML models form an “ensemble”. There are various methods for combining models. For example, they can be combined by voting, bagging or boosting.

In addition, there is also automated machine learning. Automated machine learning (AutoML) is a method by which, for given tasks or data sets, an algorithm tries to determine the best learning strategy from a certain number of machine learning methods or ML models. In AutoML, the algorithm looks for the best pre-processing steps and the best machine learning methods or the best ensemble.

AutoML can be combined with meta-learning. Meta-learning, also called “Learning to Learn”, is the science that systematically observes how different ML approaches perform in the case of a variety of learning tasks and then learns from these experiences (metadata) in order to learn new tasks much faster than would otherwise be possible.

The AUTO-SKLEARN software library provides a good implementation of AutoML. This system can form an ensemble of up to 15 estimators. In addition, up to 14 pre-processing methods for features and four pre-processing methods for data sets can also be used.

Neural networks can be, for example, “deep neural networks”, “feed forward neural networks”, “recurrent neural networks”, “convolutional neural networks” or “autoencoder neural networks”. The application of appropriate machine learning methods to neural networks is often also referred to as the “training” of the corresponding neural network.

Decision trees can be configured, for example, as “iterative dichotomizer 3” (ID3), classification or regression trees (CART) or “random forests”.

A neural network is understood as meaning, at least in connection with the present disclosure, for example, an electronic device comprising a network of “nodes”, where each node is usually connected to multiple other nodes. Furthermore, a neural network in connection with the present disclosure, for example, is further understood as meaning a computer program product that is stored in a memory device and generates such a network in accordance with the present disclosure when running on a computer. The nodes are also referred to as neurons or units, for example. Each node has at least one input connection and one output connection. Input nodes for a neural network are understood as meaning those nodes that can receive signals (data, stimuli, and/or patterns, e.g.) from the outside world. Output nodes of a neural network are understood as meaning those nodes that can pass on signals and/or, for example, to the outside world. So-called “hidden nodes” are understood as meaning those nodes of a neural network that are designed neither as input nodes nor as output nodes.

For example, the neural network can be formed as a deep neural network (DNN). Such a “deep neural network” is a neural network in which the network nodes are arranged in layers (where the layers themselves can be one-dimensional, two-dimensional or higher-dimensional). A deep neural network comprises at least one or two hidden layers that only comprise nodes that are not input nodes or output nodes. This means that the hidden layers have no connections to input signals or output signals.

So-called “deep learning” is understood as meaning, for example, a class of machine learning techniques that uses many layers of nonlinear information processing for supervised or unsupervised feature extraction and transformation, as well as for pattern analysis and classification.

For example, a neural network may also have an auto-encoder structure. Such an auto-encoder structure may be suitable, for example, for reducing a dimensionality of the data and thus, for example, detecting similarities and commonalities.

For example, a neural network may also be formed as a classification network that is particularly suitable for classifying data into categories. Such classification networks are used, for example, in connection with handwriting recognition.

Another possible structure of a neural network can be, for example, the configuration as a “deep-believe network”.

For example, a neural network may also have a combination of a plurality of the structures mentioned above. For example, the architecture of the neural network may include an auto-encoder structure to reduce the dimensionality of the input data, which structure can then be further combined with another network structure so as, for example, to detect peculiarities and/or anomalies within the data-reduced dimensionality or to classify the data-reduced dimensionality.

The values describing the individual nodes and their connections, including further values describing a particular neural network, can be stored, for example, in a value set describing the neural network. Such a value set then represents, for example, a configuration of the neural network. If such a value set is stored after the neural network has been trained, then a configuration of a trained neural network is thus stored, for example. For example, it is possible to train the neural network with appropriate training data in a first computer system, then store the corresponding value set assigned to this neural network, and transfer it to a second system as a configuration of the trained neural network.

The computer program or computer program product, which was used, is used or can be used for the training and/or the inference of the neural network and is stored, for example, in an electronic or other memory device or a computer or a computing or control device, together with the corresponding value set for this neural network, can also represent a configuration of the trained neural network. Furthermore, a further computer program or a further computer program product obtained from such a computer program or computer program product via a further compilation, optimization or processing step can also represent a configuration of the trained neural network.

A neural network can usually be trained by using a wide variety of conventional learning methods to determine parameter values for the individual nodes or for their connections by inputting input data into the neural network and analysing the then corresponding output data from the neural network. In this way, a neural network can be trained with known data, patterns, stimuli or signals in a manner known per se nowadays in order to then be able to subsequently use the network trained in this way to analyse further data, for example.

In general, the training of the neural network is understood as meaning that the data that are used to train the neural network are processed in the neural network using one or more training algorithms in order to calculate or change bias values (“bias”), weighting values (“weights”) and/or transfer functions of the individual nodes of the neural network or the connections between in each case two nodes within the neural network.

For example, one of the methods of “supervised learning” can be used to train a neural network, e.g., in accordance with the present disclosure. Here, training with corresponding training data is used to teach a network results or abilities respectively assigned to these data. Furthermore, a method of unsupervised learning can also be used to train the neural network. For example, such an algorithm generates, for a given set of inputs, a model that describes the inputs and enables predictions from them. For example, there are clustering methods that can be used to classify the data into different categories, for example if they differ from each other by characteristic patterns.

When training a neural network, supervised and unsupervised learning methods can also be combined, for example, when trainable properties or abilities are assigned to parts of the data, whereas this is not the case for another part of the data.

Furthermore, methods of reinforcement learning can also be used to train the neural network, at least among other things. For example, training that requires a relatively high computing power of a corresponding computer can take place on a high-performance system, whereas further work or data analyses with the trained neural network can then certainly be performed on a system with lower performance. Such further work and/or data analyses with the trained neural network can be carried out, for example, on an assistance system and/or on a control device, a programmable logic controller, an edge device or an edge computing device or a modular programmable logic controller or further corresponding devices in accordance with the present disclosure.

Machine learning and/or the supervision of a machine learning system work(s) in two main phases: training and inference.

Inference is the process of generating a result of the ML model by inputting new data into these models in order to produce a result, while the new data were not used to train and/or set up the ML model or the supervision artifact. For example, machine learning inference is the ability of a machine learning system to make predictions from new data. There are three key components needed for machine learning or supervision inference: a data source, a machine learning or supervision system for processing the data, and a data target.

In the training phase, a developer feeds his/her model with a curated data set so that he/she can “learn” everything he/she needs about the type of data to be analysed. In the inference phase, the model can then make predictions.

Training refers to the process of using a machine learning algorithm to create a model. Training includes the use of a deep learning framework (e.g., TensorFlow) and a training data set. Internet of Things (IoT) data provide a source of training data that can be used by data scientists and engineers to train machine learning models for a variety of use cases, from error detection to “consumer intelligence.”

Inference refers to the process of using a trained machine learning algorithm to make a prediction. IoT data can be used as an input for a trained machine learning model and enable predictions that can control the decision logic on the device, at the edge gateway, or elsewhere in the IoT system.

An elaborately trained neural network is often a bulky, massive database. There are two main approaches to taking this huge neural network and modifying it for speed and improved latency in applications that execute, for example, over other networks or on devices with lower performance.

The first approach looks at parts of the neural network that are not activated after training. These sections are not required and can be “cut away”. The second approach seeks possible ways of merging multiple layers of the neural network into a single computational step.

It is comparable to the compression that happens with a digital image. Designers may be working on these huge, beautiful images with a width and height of millions of pixels, but, when they put them online, they become a JPEG. It will be almost exactly the same, indistinguishable to the human eye, but with a smaller resolution. Similarly, the inference is almost as accurate as the prediction, but is simplified, compressed, and optimized for runtime performance.

Furthermore, a control system in accordance with the present disclosure can be configured such that the transport device comprises at least one item of identifying information, where the at least one item of identifying information and/or the first and second sensor components and the handling component are configured such that the at least one item of identifying information can be captured or is captured by the first and second sensor components and the handling component.

The handling component may also comprise one or more sensor components or one or more sensors, or such one or more sensor components or such one or more sensors can be assigned to the handling component. Here, such a sensor component or such a sensor can be configured in accordance with a sensor component or a sensor in accordance with the present disclosure. Such sensor components or such a sensor can be configured, for example, to detect a processing product such that it can then be handled or is handled according to appropriate specifications.

In this case, the first and second sensor components as well as the handling component, the sensor data supplied by the first and second sensor components and the handling component, the evaluation of these sensor data and/or the identifying information can be configured such that the identifying information can be identified or is identified as identifying information by the first and second sensor components and the handling component.

This makes it possible to determine the at least one item of time information and/or times for transporting a product transported on the transport device from the first to the second sensor component and on to the handling component based on the data relating to the identifying information that are captured by the first and second sensor components and the handling component. Thus, for example, time information can be captured in each case at the same time as sensor data are captured by the first and second sensor components and the handling component via the identifying information, for example, a “time stamp”, from which the above-mentioned at least one item of time information and/or the transport times can then be determined or is/are determined.

In this case, the identifying information can be identified as identifying information by the first and second sensor components as well as the handling component, for example, based on a position of the identifying information at the transport device, on the transport device or in relation to the transport device. Furthermore, the identifying information can be identified as identifying information by the first and second sensor components as well as the handling component, for example, based on a special shape, material property, a special surface property (e.g., color) or a combination of the above-mentioned criteria of position, shape, material property, other property, and/or surface property.

The first and second sensor components and the handling component can each use, for example, the same ones of the criteria or properties for identifying the identifying information, or different ones in each case.

For example, identifying information at the edge of a transport device, such as at the edge of a transport belt or at the edge of a transport carrier, can be attached or printed on or comparatively attached and can consist of a certain graphic symbol. The graphic symbol can be configured, for example, as an identifying code (for example, a QR code or barcode or a special symbol).

Moreover, or additionally, the identifying information can consist of, for example, a magnetic material with, for example, special magnetic properties, or can include such a material. For example, the magnetic material can be part of a graphic symbol or, for example, an independent part of the identifying information. In a combination with a graphic symbol, the magnetic material may be configured, for example, as an element formed as a carrier for the graphic symbol.

In an exemplary system, for example, a first of the sensor components can be formed as an area or line scan camera and the handling component can comprise such an area or line scan camera. Furthermore, the second sensor component can be configured as a detector for capturing magnetic properties. In such an exemplary system, identifying information explained above can be identified as described below. For example, the spatially resolving properties of the area or line scan camera can be used to identify the identifying information at the edge of the transport device. Furthermore, additionally or alternatively, the identifying information can be identified based on the spatially resolving properties of the cameras via the identifying code. The magnetic sensor can be used, for example, to determine a special magnetic property of the identifying information. In the case of a spatially resolving magnetic sensor, the identifying information can also be identified here by capturing the position at the edge of the transport device.

For example, the identifying information may be fixed to the transport device, may be permanently connected to the transport device, may be detachably connectable or connected to the transport device, may be stored on the transport device or coupled to the transport device in any other way or may be included in the transport device.

For example, the identifying information may also be directly attached to the transport device, for example printed on, glued on or comparably connected.

Furthermore, the identifying information can be connected to an object that is permanently connected to the transport device, is detachably connected to the transport device or is deposited on the transport device, or can be part of such an object.

For example, the identifying information can be configured as optically recognizable information, for example, a symbol, a barcode, a QR code, color information and/or comparable information, or can comprise such information. Furthermore, the identifying information may also include a corresponding material property, such as a certain magnetic, electrical or other material property. The identifying information may also include or consist of a specific shape, surface property, or the like.

In this case, the identifying information may be attached to an object, an assembly, an apparatus or a comparable object or may be part of this object, the assembly or the apparatus.

In this case, the identifying information, the first and second sensor components, as well as the handling component and the transport device must be arranged with respect to each other such that the identifying information can be captured or is captured by the first and second sensor components and the handling component during normal operation of the transport device.

Furthermore, the identifying information, the first and second sensor components, the handling component, as well as the identifying information must be configured and attached such that the information captured by the first and second sensor components and the handling component can be assigned to each other such that the at least one item of time information or the times for transporting a product transported on the transport device from the first to the second sensor component and on to the handling component can be determined or is/are determined.

The above-mentioned object is also achieved by a handling system for a processing product, comprising:
a control system in accordance with the disclosed embodiments,
a first sensor component of the present disclosure for connection to the at least one application module of the control device of the control system for capturing first sensor data relating to the processing product,
a second sensor component in accordance with the disclosed embodiments for connection to the at least one application module of the control device of the control system for capturing second sensor data relating to the processing product,
a handling component in accordance with the disclosed embodiments for handling, processing and/or manipulating the processing product, and
a transport device in accordance with the disclosed embodiments for transporting the processing product from the first to the second sensor component and on to the handling component.

In this case, the processing product, the control system, the first sensor component, the control device, the at least one application module, the second sensor component, the handling component and the transport device can be configured in accordance with the disclosed embodiments.

By virtue of the fact that the control system is configured to determine at least one item of time information, from which times for transporting a product transported on the transport device from the first to the second sensor component and on to the handling component can be determined, it is possible to adapt the handling system more flexibly and more easily to the handling of the processing product. In particular, a wide variety of processing products can be easily and flexibly handled in this way via appropriate sensors in a manner specifically adapted to the individual processing product.

The handling system may further be configured such that the transport device comprises at least one item of identifying information, where the at least one item of identifying information and/or the first and second sensor components and the handling component are configured such that the at least one item of identifying information can be captured or is captured by the first and second sensor components and the handling component.

In this case, the identifying information, the set-up and formation of the identifying information, the relationship of the identifying information to the transport device and to the first and second sensor components and the handling component can be configured in accordance with the disclosed embodiments.

The object and advantages are also achieved in accordance with the invention by a method for setting up a control system in accordance with the disclosed embodiments for a handling system in accordance with the disclosed embodiments, where the method comprises:
transporting identifying information in accordance with the present disclosure from the first to the second sensor component and on to the handling component, and in the process:
capturing the identifying information via the first sensor component as first sensor data and capturing a first capture time of the first sensor data, and transmitting the first capture time to the edge computing device,
capturing the identifying information via the second sensor component as second sensor data and capturing a second capture time of the second sensor data, and transmitting the second capture time to the edge computing device,
capturing the identifying information via the handling component as third sensor data and capturing a third capture time of the third sensor data, and transmitting the third capture time to the edge computing device, and
determining the at least one item of time information, where times for transporting a product transported on the transport device from the first to the second sensor component and on to the handling component can be determined or are determined from the at least one item of time information.

The method for setting up a control system in accordance with the disclosed embodiments may include, for example, calibrating the control system with respect to the at least one item of time information or the times for transporting a product from the first to the second sensor component and on to the handling component, or may be configured as a calibration of the control system with respect to the at least one item of time information or the transport times.

The method for setting up or calibrating a control system makes it possible to adapt a corresponding handling system more flexibly and easily to the handling of the processing product. In particular, a wide variety of processing products can be easily and flexibly handled in this way by means of appropriate sensors in a manner specifically adapted to the individual processing product.

The method may be configured at least partially as a computer-implemented and/or computer-aided method. In this context, at least parts of the method steps, or individual method steps, can be automated and/or computer-implemented. At least individual method steps or parts of the method steps can also be partially automated and/or computer-aided.

In particular, the method steps of capturing the identifying information via the first sensor component, via the second sensor component, and via the handling component and the associated method steps can be automated or partially automated or can be configured as computer-implemented or computer-aided method steps. The determination of the at least one item of time information can be configured, for example, as a computer-implemented method step or an automated method step.

Furthermore, in addition to transmitting the first capture time, the first sensor data and/or data derived therefrom can also be transmitted to the edge computing device. In addition to transmitting the second capture time, the second sensor data and/or data derived therefrom can also be transmitted to the edge computing device. In addition to transmitting the third capture time, the third sensor data and/or data derived therefrom can also be transmitted to the edge computing device.

Furthermore, the handling component may comprise a handling component sensor for capturing the identifying information as third sensor data. Here, the handling component sensor can be configured in accordance with a sensor component in accordance with the disclosed embodiments. For example, the handling component sensor can be configured as a camera for optically capturing the identifying information.

It may be provided, for example, that the at least one item of time information is determined in a computer-implemented and/or automated manner in the EDGE computing device. Here, the at least one item of time information, for example, can be configured such that times for transporting any product transported on the transport device from the first to the second sensor component and on to the handling component can be determined or are determined from the at least one item of time information.

The at least one item of time information can therefore consist, for example, of the times for transporting any product transported on the transport device from the first to the second sensor component and the time for transporting this product on the transport device from the second sensor component to the handling component or can comprise these transport times. Alternatively, for example, the at least one item of time information may also consist of a time for transporting a product transported via the transport device from the first sensor component to the second sensor component and a further transport time from the first sensor component to the handling component or may comprise this information.

The time information can be determined, for example, by capturing first time information when capturing the identifying information via the first sensor component, where the first time information can be established, for example, as a time stamp and/or can be assigned to further data. This first time information may include, for example, a date and a time or only a time or a system time or may be configured as a continuous counter. It may be known, for example, how long the time interval between two units of the counter clock is.

Accordingly, the second time information can then be captured when capturing the identifying information via the second sensor component and the third time information can then be captured when capturing the identifying information via the handling component. The transport time from the first sensor component to the second sensor component can then be determined, for example, by forming a corresponding difference from the first time information and the second time information. Accordingly, the transport time from the second sensor component to the handling component can be determined by forming a difference of the second time information and the third time information.

After determining the at least one item of time information, the determined at least one item of time information or of time information derived therefrom, such as a transport time from the first to the second sensor component and a further transport time from the second sensor component to the handling component, can then also be transmitted, for example, to the control module of the control system, or to a control device comprising the control module. The transmitted at least one item of time information, or transport times derived from it in accordance with the disclosed embodiments, can then be used by the control module when handling a processing product transported via the transport device.

Alternatively, the transmitted at least one item of time information, or transport times derived from it in accordance with the disclosed embodiments, is then used by the control module when handling a processing product transported via the transport device.

The objects and advantages are further achieved in accordance with the invention by a method for handling a processing product using a handling system in accordance with the disclosed embodiments, which comprises a control system set up and/or calibrated according to the present description, where the method comprises:
storing the at least one item of time information and/or the times for transporting a product transported on the transport device from the first to the second sensor component and on to the handling component in the control system,
capturing the processing product using the first sensor component at a first capture time, determining first product information from the captured first sensor data and assigning the first capture time to the first product information,
capturing the processing product using the second sensor component at a second capture time, determining second product information from the captured second sensor data and assigning the second capture time to the second product information,
assigning the first and second product information to one another by comparing a time difference between the first and second capture times and the determined time for transporting a product transported on the transport device from the first to the second sensor component, and
handling the processing product via the handling component at or from a third time that results from the second capture time and the determined time for transporting a product transported on the transport device from the second sensor component to the handling component.

The method may be configured, for example, as a computer-implemented method. Furthermore, all method steps of the method can be configured as computer-implemented method steps or common method steps. Provision may also be made for a selection of the method steps of the method to be configured as computer-implemented method steps or computer-aided method steps.

Furthermore, the method steps of the disclosed method do not necessarily have to occur one after the other or in the specified sequence. For example, they can sometimes also occur at the same time or in a different sequence.

A control system set up in accordance with a method in accordance with the disclosed embodiments for setting up and/or calibrating a control system in accordance with the disclosed embodiments may be configured, for example, such that the determined at least one item of time information and/or the transport times determined from at least one item of time information is/are input variables for controlling the handling system when handling the processing product. The determined at least one item of time information and/or the transport times determined from the at least one item of time information may be, for example, input variables for a control program for controlling the handling system when handling the processing product.

This is explained by way of example below: The handling component can thus be controlled, for example, such that, when a processing product has reached the handling component via the transport device, a handling time is determined that corresponds to the time at which the handling component is reached. The known transport times from the first sensor component to the second sensor component and from the second sensor component to the handling component are then used to determine the time at which the processing product was at the first sensor component and the time at which the processing product was at the second sensor component. The product information respectively determined at the respective times by the first and second sensor components is then used to handle the processing product via the handling component based on this product information.

For example, using the example of a recycling plant in which the handling component consists of a robot that sorts different processing products into different material-typical containers, the plant can be configured such that a material identification can occur based on the first and second product information. Thus, for example, a first sensor device formed as a camera and a second sensor device formed as a magnetic sensor can be used to perform a corresponding material classification, on the basis of which the robot can then sort the respective processing products into the corresponding containers.

A method for setting up and/or calibrating the control system in accordance with the disclosed embodiments can then be used to implement recalibration, for example, at regular time intervals, and/or if, for example, transport parameters of the transport belt or positions of the sensors or the handling component have been changed. In this way, the current times for transporting processing products transported on the transport device are available in each case.

For calibration, for example, corresponding calibration marks or components may be affixed or printed onto the transport belt and may include, for example, identifying information according to the present description. In addition, it is also possible to provide special calibration products that may also include identifying information in accordance with the disclosed embodiments and, if required, are provided or can be provided to the transport device for transport, i.e., for example, are placed or can be placed on a transport belt or transport carrier.

It may be provided, for example, that currently applicable time information and/or transport times according to the present description is/are stored in the control module or a control device comprising the control module and is/are used by a control program running in the control module to handle a processing product conveyed by the transport device.

If new, updated time information and/or corresponding transport times is/are determined, for example, by a method for setting up a control system in accordance with the disclosed embodiments, the time information and/or transport times stored in the control module, or the control device with the control module, is/are updated accordingly. This ensures that the most up-to-date time information and/or transport times is/are always available in each case when processing products via the handling component.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is explained in more detail below, by way of example, with reference to the attached drawings, in which:

FIG. 1 is an schematic illustration of a waste separation system in accordance with the invention; and

FIG. 2 is a flowchart of the method in accordance with the invention.

### DETAILED DESCRIPTION OF THE EXEMPLARY EMBODIMENTS

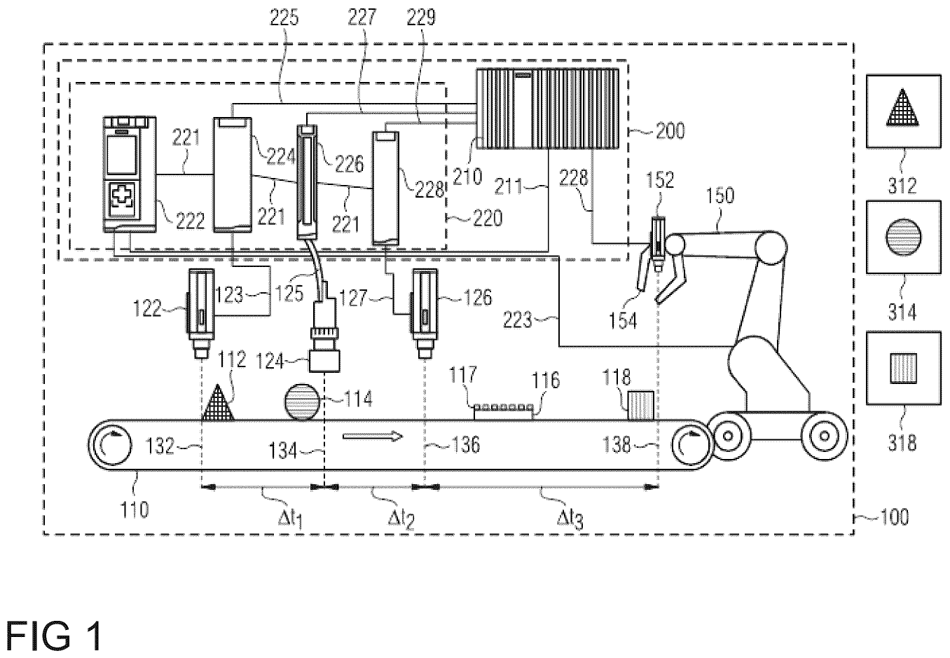

FIG. 1 illustrates a waste separation system 100 in which different waste objects 112, 114, 118 on a transport belt 110 are fed to a robot 150 that then picks them up with a gripper 154 and distributes them to corresponding receiving containers 312, 314, 318.

The shapes of the waste objects 112, 114, 118 illustrated in FIG. 1 symbolize different materials. Thus, a first plastic material is symbolized by a triangle 112, a metallic magnetic material is symbolized by a circle 114 and a second plastic material is symbolized by a square 118. The corresponding symbols are also found on receiving containers 312, 314, 318 illustrated in FIG. 1, with the result that objects made of the first plastic material are placed in the container with the triangle symbol 312, objects made of the metallic magnetic material are placed in the container with the circular symbol 314 and objects made of the second plastic material are placed in the container with the square symbol 318.

The robot 150 now has the task of transporting objects made of the first plastic material 112 into the container 312 for this first plastic material, transporting objects made of the metallic magnetic material 114 into the container 314 for these metallic magnetic materials, as well as transporting objects made of the second plastic material 118 in the corresponding container 318 for this second plastic material.

Furthermore, the waste separation system 100, which is an example of a handling system 100 in accordance with the present disclosure, comprises a hyperspectral line scan camera 122 that is capable, via machine learning, of classifying various plastic materials. Furthermore, the waste separation system 100 comprises a magnetic sensor 124 for detecting metallic magnetic objects and an RGB camera 126 for detecting a position of an object as well as its shape and size. The hyperspectral line scan camera 122 can be used to determine reliable information, for example, for identifying various plastic materials. The magnetic sensor 124 can be used to determine whether the material is a metallic magnetic material, and the RGB camera can be used, for example, to determine a position, position data and shape data relating to an object, which help the robot 150 to be able to accordingly identify and/or grip an object 112, 114, 118 transported on the transport belt 110.

The robot 150 comprises its own robot camera 152 that assists the robot in identifying and gripping an object 112, 114, 116, 118 transported on the transport belt 110 or makes it possible for the robot to perform such identification and gripping. Furthermore, the robot 150 comprises the gripper 154 for gripping an object 112, 114, 118 transported on the transport belt 110.

The waste separation system 100 further comprises a control system 200 comprising an EDGE device 210, which is an example of an edge computing device 210 in accordance with the present disclosure. Furthermore, the control system 200 comprises a control device 220 that is configured as a modular programmable logic controller (PLC) 220. The PLC 220 comprises a CPU module 222 which is an example of a control module 222 in accordance with the present disclosure. A control program for controlling the waste separation system 100, and in particular the robot 150, is stored in the control module 222. Furthermore, the PLC 220 comprises a camera module 224 that is connected to the hyperspectral line scan camera 122 via an Ethernet connection 123, an input/output module 226 that is connected to the magnetic sensor 124 via a field bus connection 125, and an ML module 228 that is configured for image analysis via machine learning methods (ML) and is connected to the RGB camera 126 via an Ethernet connection 127. The CPU module 222, the camera module 224, the input/output module 226, and the ML module 128 are communicatively connected via a backplane bus 221 of the PLC 220.

The waste separation system 100 is configured to transport and sort a large number of objects 112, 114, 118. Knowing the times needed by the object 118, which is currently located under the gripper 154 of the robot 150, from the hyperspectral line scan camera 122 to the magnetic sensor 124, then on to the RGB camera 126, and from there to the gripper 154 of the robot 150 is a possible way of providing the robot 150 with the information it needs to then move this object 118 into the correct container 318, as explained in more detail below.

In FIG. 1, a transport time from the hyperspectral camera 122 to the magnetic sensor 124 is entered as Δt₁, the transport time from the magnetic sensor 124 to the RGB camera 126 is entered as Δt₂, and the transport time from the RGB camera 126 to the gripper of the robot 154 is entered as Δt₃. If the object 118 to be sorted now reaches the gripper 154 of the robot 150 at a time T, those data which were measured at a time T−Δt₁−Δt₂−Δt₃ are selected from the measured sensor data from the hyperspectral camera 122. Furthermore, the data that were measured at a time T−Δt₃−Δt₂ are selected from the data from the magnetic sensor 124. In addition, those data that were measured at a time T−Δt₃ are selected from the data from the RGB camera 126. This selection is performed (at least inter alia) by the control program running in the CPU module 222. Based on the determined data, the control program then further determines the material of which the object 118 on the gripper 154 is made, and the robot 150 is then controlled such that the object 118 is placed in the associated container 318.

Here, the square object 118 made of the second plastic material is located below the gripper 114. With the robot camera 152, the square object 118 is captured and the capture time T is determined. In accordance with above-described procedure, it then follows from the data from the hyperspectral camera 122 that it is the second plastic material, the magnetic sensor 124 has not detected any magnetic material and the RGB camera has determined the associated position and a possible gripping point of the object 118. Based on these data, the control program running in the CPU module determines that the square object 118 consists of the second plastic material and the points at which the gripper 154 has to start in order to grasp it. The control program then controls the placing of the square object 118 in the associated storage container 318 by the robot 150.

In order to determine the transport times Δt₁, Δt₂ and Δt₃, a calibration element 116 is further provided and comprises a barcode 117. The barcode 117 is an example of identifying information 117 in accordance with the present disclosure.

In order to calibrate the waste separation system 110 with respect to the transport times Δt₁, Δt₂ and Δt₃, the calibration element 116 is now placed on the transport belt 110 and transported from the hyperspectral camera 122 via the magnetic sensor 124 and the RGB camera 126 to the gripper 154 of the robot 150 with its camera 152. When the hyperspectral camera 122 is reached, it detects via the barcode 117 that it is the calibration element 116 and captures the time at which the calibration element 116 passes the optical axis 132 of the hyperspectral camera 122. The detection of the calibration element 116 by the magnetic sensor 124 can be performed either such that the barcode 117 is produced from magnetic materials and the magnetic sensor 124 can detect the barcode 117 on the basis of said materials. Alternatively, the magnetic sensor 124 can comprise its own optical camera. This can optically detect the object located below the magnet sensor 124 and can then determine via the barcode whether and/or when the calibration element 116 is located under the magnet sensor 124.

After the magnetic sensor 124 has detected the identifying information 117 relating to the calibration element 116 by means of, for example, one of the two above-mentioned methods, the time at which the calibration element 116 has passed a measuring axis 134 of the magnetic sensor 134 is also in turn captured here.

The RGB camera 126 optically detects the barcode 117 of the calibration element 116 and then also captures the time at which the calibration element 116 has passed the optical axis 136 of the RGB camera 136. Likewise, the robot camera 152 can subsequently capture the barcode 117 of the calibration element 116 and in turn determine the time T at which the calibration element 116 passes or reaches the optical axis 138 of the robot camera 152.

The time at which the calibration element 116 passes the hyperspectral camera 122 can be determined, for example, by identifying, in the camera module 224 of the PLC 220, that the currently captured image is the calibration element 116 and then also recording, in the camera module 224, the time at which the currently captured image was recorded. This time is then transmitted, together with the information that it is the calibration element 116, to the edge device 210 via a field bus 225. In the same way, the calibration element 116 is detected by the input/output module 226 assigned to the magnetic sensor 124, the corresponding time is recorded and is also correspondingly transmitted to the edge device via a field bus 227. Similarly, the calibration element 116 is detected via the ML module 228 connected to the RGB camera 226 and the corresponding recording time is recorded and transmitted to the edge device 210 via a field bus 229.

The robot camera 152 comprises its own image evaluation device for detecting the calibration element 116 and also has the possibility of determining a corresponding recording time. After the calibration element 116 has also reached the robot camera 152, this is detected by the image evaluation system of the robot camera 152, the corresponding time at which the calibration element 116 has reached the optical axis of the robot camera 138 is recorded and this time is transmitted to the edge device 210 via a further field bus connection 228.

The transport times Δt₁, Δt₂ and Δt₃ are then calculated by the edge device 210 from the measured times at which the calibration element 116 has passed the respective sensors 122, 124, 126, 152. These transport times represent an exemplary embodiment of the at least one item of time information in accordance with the disclosure. The above-mentioned calculation of these transport times is an exemplary embodiment of the determination of the at least one item of time information in accordance with the present disclosure.

These times Δt₁, Δt₂ and Δt₃ are then supplied to the CPU module 222 of the PLC 220 via an OPC-UA communication connection, stored there and used for the next operations for sorting the objects 112, 114, 118 transported by the transport belt 110.

For example, the calibration element 116 can be placed on the transport belt 110 and used to calibrate the waste separation system 100 whenever, for example, a setting parameter, such as a speed of the transport belt 110, has been changed. Furthermore, the waste separation system 100 can also be accordingly calibrated via the calibration element 116 at regular time intervals in order to regularly check the transport times Δt₁, Δt₂ and Δt₃, for example, in order to detect and take into account, for example, a change in the transport conditions due to external circumstances, such as temperature, humidity, and/or heating of motors.

The calibration element 116 may also be fixedly or detachably connected to the transport belt 110, for example. In an alternative embodiment, the barcode 117 may also be printed as identifying information on the transport belt 110. This makes it possible to achieve, for example, the situation in which the waste separation system 100 is calibrated at regular time intervals in the present embodiment once per revolution of the transport belt.

In a further embodiment, multiple calibration elements 116 can also be fixed or detachably fixed on the transport belt. Each of the calibration elements may comprise the same barcode 117 or, advantageously, different barcodes 117. In an alternative embodiment, the barcode 117 may also be printed on the transport belt several times, or different barcodes 117 may be printed on the transport belt.

This achieves even more frequent calibration of the waste separation system. For example, changes in the waste separation system 100, for example caused by drifting in the transport belt movement or the sensor system, can then be corrected even more promptly and accurately.

Using the EDGE device 210 to calculate the calibration parameters and collect the necessary information improves the performance of the waste separation system 100. Using the EDGE device 210 as described to calibrate the waste separation system 100 relieves the load on the PLC 220, with the result that the real-time control processes, which are controlled by the PLC 220 (e.g., sorting the waste objects 112, 114, 118 into the corresponding containers 312, 314, 318), are not delayed by the calibration, in particular are not delayed, for example, by the detection, collection and processing of data needed for calibration.

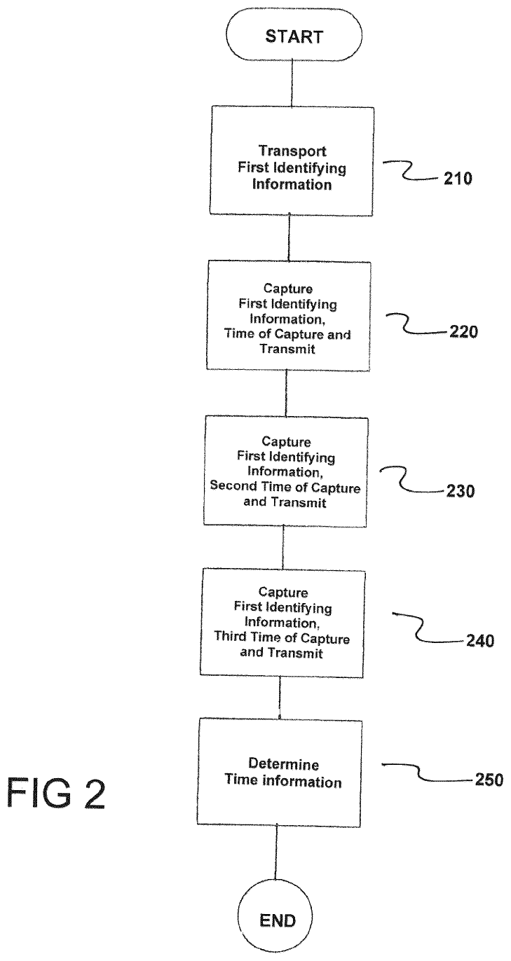

FIG. 2 is a flowchart of the method for setting up a control system 200 for a handling system. The method comprises transporting an item of first identifying information 117 of the at least one item of identifying information 117 from a first to a second sensor component 122, 124, 126 and on to a handling component 150, as indicated in step 210.

In so doing, the item of first identifying information 117 is captured via the first sensor component 122, 124, 126 as first sensor data and a first capture time of the first sensor data is captured, and transmitting the first capture is transmitted to an edge computing device 210, as indicated in step 220.

Next, the item of first identifying information 117 is captured via the second sensor component 122, 124, 126 as second sensor data and a second capture time of the second sensor data is captured, and the second capture time is transmitted to the edge computing device 210, as indicated in step 230.

Next, the item of first identifying information 117 is captured via the handling component 150 as third sensor data and a third capture time of the third sensor data is captured, and the third capture time is transmitted to the edge computing device, as indicated in step 240.

Next, the at least one item of time information is determined, as indicated in step 250.

In accordance with the method of the invention, times for transporting a product transported on a transport device from the first to the second sensor component and on to the handling component are determinable or are determined from the at least one item of time information.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A control system for handling a processing product transported on a transport device from a first to a second sensor component and on to a handling component, comprising:
a control device including:
at least one application module for connecting the first sensor component and the second sensor component; and
a control module configured to execute a control program for controlling the handling component; and
an edge computing device which is configured to determine at least one item of time information, times for transporting a product transported on the transport device from the first to the second sensor component and on to the handling component being determinable or determined from the at least one item of time information;
wherein the first and second sensor components are configured to capture first and second sensor data relating to the processing product, the handling component being configured to at least one of handle, process and manipulate the processing product; and
wherein the control module is further configured to execute the control program to provide real-time control of the handling component for handling the processing product taking into account the first and second sensor data as well as at least one of the time information and the determined transport times.

2. The control system as claimed in claim 1, wherein the at least one application module is configured to determine first product information utilizing the first sensor data and second product information utilizing the second sensor data; and
wherein the control module is further configured to execute a control program for the real-time control of the handling component for handling the processing product taking into account the first and second product information relating to the processing product as well as at least one of the time information and the determined transport times.

3. The control system as claimed in claim 2, wherein the at least one application module comprises at least one of a first machine learning (ML) model for determining the first product information and a second ML model for determining the second product information.

4. The control system as claimed in claim 1, wherein the transport device comprises at least one item of identifying information; and
wherein at least one of (i) the at least one item of identifying information and (ii) the first and second sensor components and the handling component are configured such that the at least one item of identifying information is captured by the first and second sensor components and the handling component.

5. The control system as claimed in claim 2, wherein the transport device comprises at least one item of identifying information; and
wherein at least one of (i) the at least one item of identifying information and (ii) the first and second sensor components and the handling component are configured such that the at least one item of identifying information is captured by the first and second sensor components and the handling component.

6. The control system as claimed in claim 3, wherein the transport device comprises at least one item of identifying information; and
wherein at least one of (i) the at least one item of identifying information and (ii) the first and second sensor components and the handling component are configured such that the at least one item of identifying information is captured by the first and second sensor components and the handling component.

7. A handling system for a processing product, comprising:
a control system as claimed in claim 1;
a first sensor component as claimed in claim 1 for connection to the at least one application module of the control device for capturing first sensor data relating to the processing product;
a second sensor component as claimed in claim 1 for connection to the at least one application module of the control device for capturing second sensor data relating to the processing product;
a handling component as claimed in any one of claim 1 for at least one of handling, processing and/or manipulating the processing product; and
a transport device as claimed in claim 1 for transporting the processing product from the first to the second sensor component and on to the handling component.

8. The handling system as claimed in claim 7, wherein the transport device comprises at least one item of identifying information; and
wherein at least one of (i) the at least one item of identifying information and (ii) the first and second sensor components and the handling component are configured such that the at least one item of identifying information is captured by the first and second sensor components and the handling component.

9. A method for setting up a control system for a handling system, the method comprising:
transporting an item of first identifying information of the at least one item of identifying information from a first to a second sensor component and on to a handling component;
capturing the item of first identifying information via the first sensor component as first sensor data and capturing a first capture time of the first sensor data, and transmitting the first capture time to an edge computing device;
capturing the item of first identifying information via the second sensor component as second sensor data and capturing a second capture time of the second sensor data, and transmitting the second capture time to the edge computing device;
capturing the item of first identifying information via the handling component as third sensor data and capturing a third capture time of the third sensor data, and transmitting the third capture time to the edge computing device; and
determining the at least one item of time information;
wherein times for transporting a product transported on a transport device from the first to the second sensor component and on to the handling component are determinable or are determined from the at least one item of time information.

10. A method for handling a processing product utilizing a handling system including a control system set up via the method as claimed in claim 7, the method comprising:
storing at least one of the at least one item of time information and the times for transporting a product transported on the transport device from the first to the second sensor component and on to the handling component in the control system;
capturing the processing product utilizing the first sensor component at a first capture time, determining first product information from the captured first sensor data and assigning the first capture time to the first product information;
capturing the processing product utilizing the second sensor component at a second capture time, determining second product information from the captured second sensor data and assigning the second capture time to the second product information;
assigning the first and second product information to one another by comparing a time difference between the first and second capture times and the determined time for transporting a product transported on the transport device from the first to the second sensor component; and
handling the processing product via the handling component at or from a third time which results from the second capture time and the determined time for transporting a product transported on the transport device from the second sensor component to the handling component.
